(19) United States
(12) Patent Application Publication
(10) Pub. No.: US 2010/0025060 A1
(43) Pub. Date: Feb. 4, 2010

(54) SILICON LUMP CRUSHING TOOL

(76) Inventors: Yasuo Yamane, Hiroshima (JP); Keiji Yamada, Hiroshima (JP); Yuji Iseki, Yamaguchi (JP); Manabu Kondou, Yamaguchi (JP)

Correspondence Address: BIRCH STEWART KOLASCH & BIRCH, PO BOX 747, FALLS CHURCH, VA, 22040-0747, US

(21) Appl. No.: 12/443,938

(22) PCT Filed: Oct. 11, 2007
(86) PCT No.: PCT/JP2007/070303

§ 371 Date: Apr. 1, 2009

(51) Int. Cl. B25D 9/04; B25D 17/06

(52) U.S. Cl. 173/114; 173/126; 173/210

(57) ABSTRACT

A silicon lump crushing tool comprising a pneumatic piston drive means for driving a piston installed in a casing from a retreat position to a projection position by air pressure, a guide tube connected to the casing and extending in the movement direction of the piston, and a hammer head. The rear end portion of the hammer head is movably inserted into the front end portion of the guide tube, and when the piston is driven from the retreat position to the projection position, the front end of the piston collides with the rear end of the hammer head.

### TECHNICAL FIELD

The present invention relates to a silicon lump crushing tool which can be advantageously used to crush a silicon lump, especially a polycrystalline silicon rod, so as to obtain fist-sized small pieces, called “nuggets”.

### BACKGROUND ART

As already known, a silicon wafer for the manufacture of a semiconductor device is produced as follows. A polycrystalline silicon rod lump is first produced by the Siemens method and then crushed into fist-sized small pieces. Then, a columnar monocrystalline silicon ingot is produced from the crushed silicon small pieces as raw materials by the Czochralski method, cut and ground, whereby a silicon wafer is obtained.

JP-A 2-152554 discloses a crushing apparatus for crushing the above polycrystalline silicon rod lump into small pieces by compressing it among a plurality of high-purity silicon columns. Further, JP-A 10-6242 discloses a manual hammer for hammering the above polycrystalline silicon rod to crush it into small pieces.

The crushing apparatus disclosed by the above JP-A 2-152554 is very expensive as its constitution is very complex and it requires high horsepower. According to the experience of the inventors of the present invention, a large amount of powders which cannot be used effectively is produced at the time of crushing in the crushing apparatus disclosed by the above JP-A 2-152554 and therefore, there is also a problem that the yield of small pieces is low. Meanwhile, crushing with the manual hammer disclosed by the above JP-A 10-6242 has such problems that as the workload is markedly large, considerable skill is needed to crush silicon into required small pieces, and great physical force is required.

### DISCLOSURE OF THE INVENTION

The present invention has been made in view of the above fact, and its principal object is to provide a novel silicon lump crushing tool which is capable of crushing a silicon lump, especially a polycrystalline silicon lump rod into small pieces having a required size without producing a large amount of powders and without requiring an excessive workload, considerable skill and physical force though it is relatively inexpensive.

According to the present invention, the above principal object is attained by a silicon lump crushing tool comprising a pneumatic piston drive means for driving a piston which is installed in a casing in such a manner that it can move between a retreat position and a projection position and is driven from the retreat position to the projection position by air pressure;

a guide tube connected to the casing and extending in the movement direction of the piston; and

a hammer head, wherein

when the piston is located at the retreat position, the front end of the piston advances into the rear end portion of the guide tube or is positioned behind from the rear end of the guide tube, and the rear end portion of the hammer head is movably inserted into the front end portion of the guide tube, and when the piston is driven from the retreat position to the projection position, the front end of the piston collides with the rear end of the hammer head.

Preferably, the tool further comprises a hammer head guide member which is located anterior to and separately from the front end of the guide tube, a guide through-hole extending in the movement direction of the piston is formed in the guide member, and the front end portion of the hammer head is inserted into the guide through-hole. A flange is formed at the intermediate portion in the longitudinal direction of the hammer head, and the hammer head can preferably move between a retreat position where the rear face of the flange comes into contact with the front end of the guide tube and a projection position where the front face of the flange comes into contact with the rear face of the guide member. Preferably, an impact absorbing member is provided on the rear face of the guide member. The front end of the hammer head is hemispherical with a curvature radius of preferably 75 to 300 mm, particularly preferably 100 to 200 mm. It is advantageous that at least the front end portion of the hammer head should be made of cemented carbide. Desirably, the guide tube, the hammer head and the guide member are covered with a synthetic resin sheet excluding the area of the guide through-hole formed in the front face of the guide member.

Although the silicon lump crushing tool of the present invention can be manufactured at a relatively low cost, when the silicon lump crushing tool of the present invention is used, a silicon lump, especially a polycrystalline silicon rod lump can be crushed into small pieces having a required size without producing a large amount of powders and without requiring an excessive workload, considerable skill and physical force.

### BRIEF EXPLANATION OF THE DRAWINGS

FIG. 1 is a front view of a silicon lump crushing tool constituted according to a preferred embodiment of the present invention;

FIG. 2 is a sectional view showing part of the silicon lump crushing tool shown in FIG. 1; and

FIG. 3 is a partial sectional view showing a way of crushing a silicon lump by using the silicon lump crushing tool shown in FIG. 1.

### BEST MODE FOR CARRYING OUT THE INVENTION

A silicon lump crushing tool constituted according to a preferred embodiment of the present invention will be described in more detail with reference to the accompanying drawings.

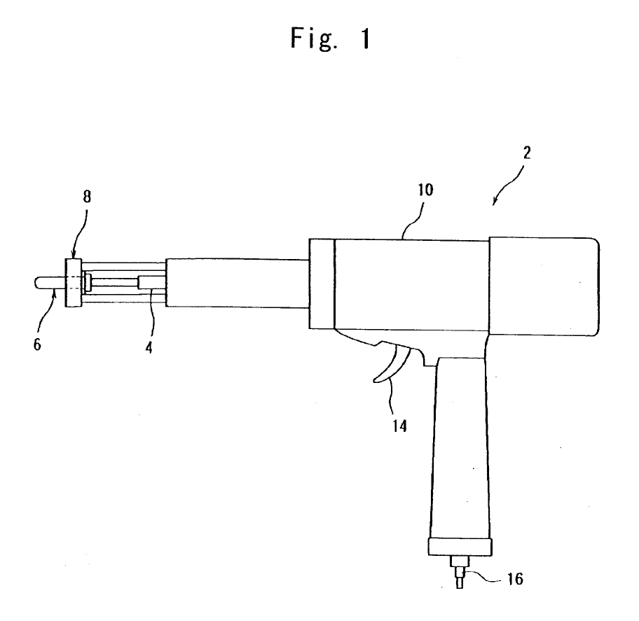

FIG. 1 illustrates diagrammatically the whole silicon lump crushing tool constituted according to the preferred embodiment of the present invention. The illustrated silicon lump crushing tool comprises a pneumatic piston drive means 2, a guide tube 4, a hammer head 6 and a hammer head guide member 8.

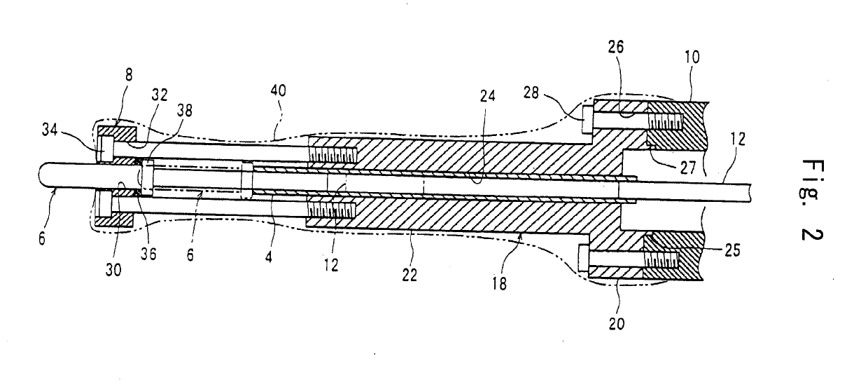

Continuing the description with reference to FIG. 2 together with FIG. 1, the pneumatic piston drive means 2 comprises a pistol-like casing 10, a piston 12 which is installed in the casing 10 in such a manner that it can move between a retreat position indicated by a solid line in FIG. 2 and a projection position indicated by a dashed-two dotted line, a trigger 14 fitted to the casing 10 and a plug 16 provided on the casing 10. The plug 16 is connected to an air compressor (not shown) via a hose (not shown) . When the trigger 14 is pulled against the bias function of an elastic bias spring (not shown) by putting a finger on the trigger 14, the piston 12 is driven from the retreat position to the projection position by the action of high-pressure air and when the trigger 14 is released, the piston 10 is returned to the retreat position from the projection position. It is advantageous that the pressure of the high-pressure air for driving the piston 10 should be approximately 0.5 to 1.0 MPa from the viewpoints of the strength of each member and operation safety. The pneumatic piston drive means 2 itself may be a known means. For example, a pneumatic piston drive means used in a high-pressure roll nailer marketed from Hitachi Koki Co., Ltd. under the trade name of “NV 100H”, namely, its body portion excluding a nailing magazine which is detachably mounted, can be advantageously used. Therefore, a detailed description of the pneumatic piston drive means 2 is not given in this text.

As clearly illustrated in FIG. 2, a connection member 18 is fixed to the casing 10 of the pneumatic piston drive means 2. The connection member 18 which may be made of a suitable material such as metal, synthetic resin-coated metal or synthetic resin has a base portion 20 having a relatively large diameter and a main portion 22 having a relatively small diameter. A through-hole 24 is formed in the connection member 18 penetrating in the center axial direction. The rear end portion, that is, the right end portion in FIG. 2 of the through-hole 24 having a circular cross section is expanded to have a relatively large diameter. An annular projection 25 projecting backward is formed on the rear face of the connection member 18. Further, a plurality of (for example, 4) through-holes 26 are formed in the base portion 20 of the connection member 18 at intervals in the circumferential direction. The annular projection 25 of the connection member 18 is positioned in the annular dent 27 of the casing 10, and fastening bolts 28 are screwed into the screw holes of the casing 10 through the through-holes 26 formed in the base portion 20 to fix the connection member 18 to the casing 10. The above guide tube 4 which may be made of a suitable material such as metal, synthetic resin-coated metal or synthetic resin is fixed in the through-hole 24 of the connection member 18 by a suitable manner such as press-fitting. The rear end portion of the guide tube 4 which is cylindrical is positioned in the expanded rear end portion of the through-hole 24, and the front end portion of the guide tube 4 projects forward from the through-hole 24. As clearly understood from FIG. 2, the guide tube 4 extends in the movement direction of the piston 12 of the pneumatic piston drive means 2, and the inner diameter of the guide tube 4 corresponds to the outer diameter of the piston 12. In the illustrated embodiment, when the piston 12 is located at the above retreat position, the front end of the piston 12 is situated in the rear end of the guide tube 4. If desired, the front end of the piston 12 may be designed to be positioned behind the rear end of the guide tube 4 when the piston 12 is at the above retreat position. When the piston 12 is driven to the projection position, the front end of the piston 12 is positioned in the front end portion of the guide tube 4.

Describing the hammer head guide member 8 prior to the description of the hammer head 6 for the convenience of explanation, the guide member 8 which may be made of a suitable material such as metal, synthetic resin-coated metal or synthetic resin is shaped like a disk, and a through-hole 30 having a circular cross section is formed in the center of the guide member 8. A plurality of (for example, 4) through-holes 32 are further formed in the peripheral portion of the guide member 8 at intervals in the circumferential direction. The front end portion of each of the through-holes 32 having a circular cross section is expanded to have a large diameter. The guide member 8 is fixed to the connection member 18 by screwing fastening bolts 34 into screw holes formed in the front end portion of the above connection member 18 through the through-holes 32. The head portions of the fastening bolts 34 are folded in the expanded portions of the through-holes 32. As clearly shown in FIG. 2, the guide member 8 is located anterior to and separately from the front end of the guide tube 4. The center axis of the through-hole 30 formed in the center of the guide member 8 is aligned with the center axis of the guide tube 4. It is preferred that a ring-shaped impact absorbing member 36 should be fixed on the rear face of the guide member 8. The impact absorbing member 36 may be made of a suitable impact absorbing material such as hard synthetic rubber.

The hammer head 6 in the illustrated embodiment is shaped like a round rod as a whole, and an annular flange 38 is formed at the center portion in the longitudinal direction of the hammer head 6. The outer diameter of the rear portion located posterior to the flange 38 corresponds to the inner diameter of the above guide tube 4. The outer diameter of the front portion located anterior to the flange 38 is slightly larger than the outer diameter of the rear portion and corresponds to the inner diameter of the through-hole 30 formed in the center of the guide member 8.

The front end of the hammer head 6 is hemispherical with a curvature radius of preferably 75 to 300 mm, particularly preferably 100 to 200 mm. As understood from Experimental Examples which will be described later, when the curvature radius becomes too small, cracking does not reach the inside of the silicon lump and hence, excessive energy is required to crush the silicon lump, the number of times of causing the hammer to collide with the silicon lump to crush it into small pieces having a required size becomes too large, and a large amount of powders (that are small pieces having a too small size) which cannot be used effectively is produced. Meanwhile, when the curvature radius is too large, the angulated portion of the hammer head 6 collides with the silicon lump, in the case where the angle of the hammer head with respect to the silicon lump slightly changes, whereby it is apt to become difficult to provide energy required for crushing to the silicon lump effectively. Also, the number of times of causing the hammer to collide with the silicon lump to crush it into small pieces having a required size becomes too large, and a large amount of powders (that are small pieces having a too small size) which cannot be used effectively is produced, like when the curvature radius is too small.

The rear end portion of the hammer head 6 is inserted into the front end portion of the guide tube 4, and the front end portion is inserted into the through-hole 30 of the guide member 8. Therefore, the hammer head 6 can move between a retreat position (position indicated by a dashed-two dotted line in FIG. 2) where the rear face of the flange 38 comes into contact with the front end of the guide tube 4 and a projection position (position indicated by a solid line in FIG. 2) where the front face of the flange 38 comes into contact with the rear face of the guide member 8, more specifically, the impact absorbing member 36 fixed on the rear face. At least the front end portion of the hammer head 6 is desirably made of cemented carbide having a Rockwell A hardness (HRA) of 80 or more, for example, cemented carbide comprising tungsten carbide and cobalt as the main components. Whole the hammer head 6 may be made of cemented carbide, or the front end portion made of cemented carbide may be fixed to the remaining portion made of another suitable metal by a suitable means such as welding.

As schematically illustrated by a dashed-two dotted line in FIG. 2, in the illustrated embodiment, the guide member 8, the fastening bolts 34, the hammer head 6 and the connection member 18 are covered with a synthetic resin film 40 excluding the area of the through-hole 30 in the front face of the guide member 8. It is important that the synthetic resin film 40 should not contain a component having a bad influence on silicon when silicon comes into contact with the synthetic resin film 40.

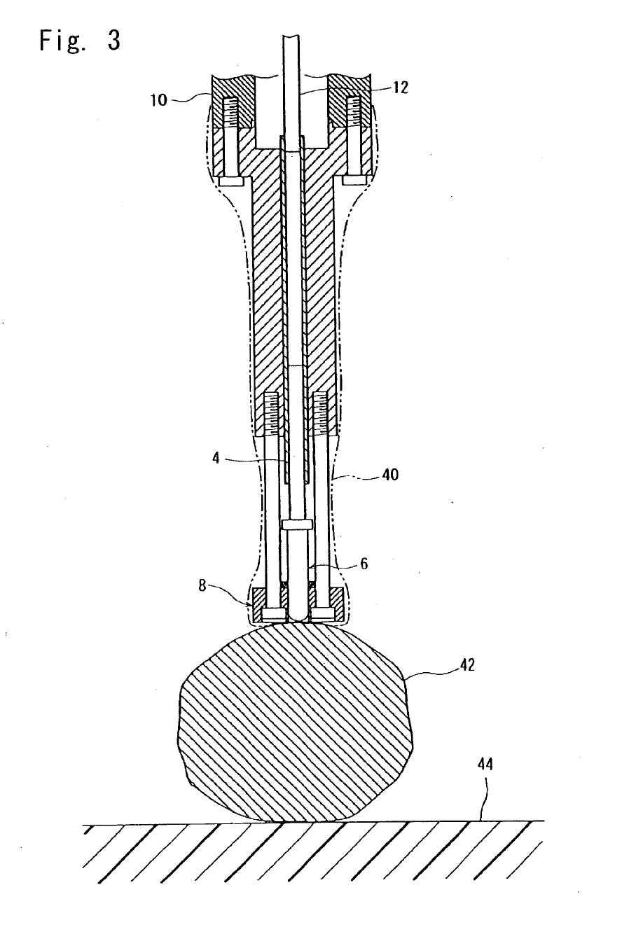

A description is subsequently given of a preferred way of crushing the silicon lump by using the illustrated silicon lump crushing tool with reference to FIG. 3 together with FIG. 1 and FIG. 2. The polycrystalline silicon rod 42 to be crushed into small pieces is placed on a table 44 made of a suitable synthetic resin. And, as shown in FIG. 3, the front face of the guide member 8 of the silicon lump crushing tool is brought into contact with the silicon 42. When this is done, the hammer head 6 is moved backward from the projection position to a position where the front end thereof is substantially aligned with the front face of the guide member 8. When the trigger 14 of the piston drive means 2 is pulled in this state, the piston 12 is driven from the retreat position indicated by the solid line in FIG. 2 to the projection position indicated by the dashed-two dotted line in FIG. 2 by high-pressure air and the front end of the piston 12 collides with the rear end of the hammer head 6. Thus, a required impact is applied to the silicon 42 through the hammer head 6 to crush the silicon 42. When the trigger 14 of the piston drive means 2 is released, the piston 12 is returned to the retreat position indicated by the solid line in FIG. 2. By suitably moving the position of the guide member 8 relative to the silicon 42 to repeat the operation of the trigger 14 of the piston drive means 2, the whole polycrystalline silicon rod 42 can be crushed into small pieces having a suitable size. The intensity of the impact to be applied to the silicon 42 to be crushed can be adjusted by suitably selecting the pressure of high-pressure air for driving the piston 12 (as described above, the pressure of the high-pressure air is preferably approximately 0.5 to 1.0 MPa). Therefore, the silicon 42 can be crushed fully easily without requiring special skill and great physical force. In addition, as understood from Experimental Examples which will be described later, the generation of powders at the time when the silicon 42 is crushed can be fully suppressed by setting the curvature radius of the front end of the hammer head 6 and the intensity of the impact to be applied to the silicon 42 to appropriate values.

### EXPERIMENTAL EXAMPLES

### Experimental Example 1

A columnar polycrystalline silicon lump having a length of 200 mm and a diameter of 120 mm (therefore, a curvature radius of 60 mm) produced by the Siemens method was crushed by using the silicon lump crushing tool of the figuration illustrated in FIG. 1 and FIG. 2 according to the mode as described with reference to FIG. 3. The forefront of the hammer head was caused a collision with the side surface of the silicon lump. After the second collision, the hammer was caused a collision with the side surface maintaining the initial state of a portion which remained as a relatively large lump. The curvature radius of the forefront of the hammer head was 25 mm, the pressure of the high-pressure air supplied to drive the piston was 0.9 MPa, and the number of times of the collision between the hammer head and the silicon lump was 18. The crushed small pieces were sorted into a group having a maximum length of more than 120 mm (too large as a raw material in the Czochralski method), a group having a maximum length of 10 to 120 mm (suitable as a raw material in the Czochralski method) and a group having a maximum length of less than 10 mm (too small as a raw material in the Czochralski method) to obtain the weight ratio of each of these groups. The results are shown in Table 1.

### Experimental Example 2

The same experiment as in Experimental Example 1 was conducted to sort the crushed small pieces and obtain the weight ratio of each of the groups of the small pieces except that the curvature radius of the forefront of the hammer head was 75 mm and the number of times of the collision between the hammer head and the silicon lump was 6. The results are shown in Table 1.

### Experimental Example 3

The same experiment as in Experimental Example 1 was conducted to sort the crushed small pieces and obtain the weight ratio of each of the groups of the small pieces except that the curvature radius of the forefront of the hammer head was 100 mm and the number of times of the collision between the hammer head and the silicon lump was 4. The results are shown in Table 1.

### Experimental Example 4

The same experiment as in Experimental Example 1 was conducted to sort the crushed small pieces and obtain the weight ratio of each of the groups of the small pieces except that the curvature radius of the forefront of the hammer head was 150 mm and the number of times of the collision between the hammer head and the silicon lump was 4. The results are shown in Table 1.

### Experimental Example 5

The same experiment as in Experimental Example 1 was conducted to sort the crushed small pieces and obtain the weight ratio of each of the groups of the small pieces except that the curvature radius of the forefront of the hammer head was 200 mm and the number of times of the collision between the hammer head and the silicon lump was 5. The results are shown in Table 1.

### Experimental Example 6

The same experiment as in Experimental Example 1 was conducted to sort the crushed small pieces and obtain the weight ratio of each of the groups of the small pieces except that the curvature radius of the forefront of the hammer head was 300 mm and the number of times of the collision between the hammer head and the silicon lump was 8. The results are shown in Table 1.

### Experimental Example 7

The same experiment as in Experimental Example 1 was conducted to sort the crushed small pieces and obtain the weight ratio of each of the groups of the small pieces except that the curvature radius of the forefront of the hammer head was 350 mm and the number of times of the collision between the hammer head and the silicon lump was 14. The results are shown in Table 1.

### Experimental Example 8

The same experiment as in Experimental Example 1 was conducted to sort the crushed small pieces and obtain the weight ratio of each of the groups of the small pieces except that the pressure of the high-pressure air was 1.8 MPa and the number of times of the collision between the hammer head and the silicon lump was 4. The results are shown in Table 1.

### Experimental Example 9

The same experiment as in Experimental Example 1 was conducted to sort the crushed small pieces and obtain the weight ratio of each of the groups of the small pieces except that the pressure of the high-pressure air was 1.8 MPa and the number of times of the collision between the hammer head and the silicon lump was 3. The results are shown in Table 1.

### Experimental Example 10

The same experiment as in Experimental Example 1 was conducted to sort the crushed small pieces and obtain the weight ratio of each of the groups of the small pieces except that the pressure of the high-pressure air was 2.2 MPa and the number of times of the collision between the hammer head and the silicon lump was 3. The results are shown in Table 1.

TABLE 1

| | | | curvature of | | | | | |
|---|---|---|---|---|---|---|---|---|
| | air | impact | forefront of | number of | yield of crushed small pieces (%) | | | |
| Exptl. | pressure | energy | hammer head | times of | More than | 10 to | less than | total |
| Ex. | (MPa) | (J) | (mm) | collision | 120 mm | 120 mm | 10 mm | (gross weight) |
| 1 | 0.9 | 35 | 25 | 18 | 35.4 | 56.8 | 7.8 | 100% (7 Kg) |
| 2 | 0.9 | 35 | 75 | 6 | 6.2 | 92.1 | 1.7 | 100% (7 Kg) |
| 3 | 0.9 | 35 | 100 | 4 | 0.9 | 98.0 | 1.1 | 100% (7 Kg) |
| 4 | 0.9 | 35 | 150 | 4 | 1.4 | 97.3 | 1.3 | 100% (7 Kg) |
| 5 | 0.9 | 35 | 200 | 5 | 3.1 | 95.9 | 1 | 100% (7 Kg) |
| 6 | 0.9 | 35 | 300 | 8 | 5.4 | 91.7 | 2.9 | 100% (7 Kg) |
| 7 | 0.9 | 35 | 350 | 14 | 15.9 | 79.4 | 4.7 | 100% (7 Kg) |
| 8 | 1.8 | 80 | 25 | 4 | 0.9 | 98.2 | 0.9 | 100% (7 Kg) |
| 9 | 1.8 | 80 | 100 | 3 | 0.7 | 98.4 | 0.9 | 100% (7 Kg) |
| 10 | 2.2 | 100 | 25 | 3 | 0.8 | 98.4 | 0.8 | 100% (7 Kg) |

Exptl. Ex. = Experimental Example

1. A silicon lump crushing tool comprising:
a pneumatic piston drive means for driving a piston which is installed in a casing in such a manner that it can move between a retreat position and a projection position and is driven from the retreat position to the projection position by air pressure;
a guide tube connected to the casing and extending in the movement direction of the piston; and
a hammer head, wherein
when the piston is located at the retreat position, the front end of the piston advances into the rear end portion of the guide tube or is positioned behind from the rear end of the guide tube, and the rear end portion of the hammer head is movably inserted into the front end portion of the guide tube, and when the piston is driven from the retreat position to the projection position, the front end of the piston collides with the rear end of the hammer head.

2. The silicon lump crushing tool set forth in claim 1, wherein the tool comprises a hammer head guide member which is located anterior to and separately from the front end of the guide tube, a guide through-hole extending in the movement direction of the piston is formed in the guide member, and the front end portion of the hammer head is inserted into the guide through-hole.

3. The silicon lump crushing tool set forth in claim 3, wherein a flange is formed at the intermediate portion in the longitudinal direction of the hammer head, and the hammer head can move between a retreat position where the rear face of the flange comes into contact with the front end of the guide tube and a projection position where the front face of the flange comes into contact with the rear face of the guide member.

4. The silicon lump crushing tool set forth in claim 3, wherein an impact absorbing member is provided on the rear face of the guide member.

5. The silicon lump crushing tool set forth in any one of claims 1 to 4, wherein the front end of the hammer head is hemispherical with a curvature radius of 75 to 300 mm.

6. The silicon lump crushing tool set forth in claim 5, wherein the front end of the hammer head is hemispherical with a curvature radius of 100 to 200 mm.

7. The silicon lump crushing tool set forth in claim 1, wherein at least the front end portion of the hammer head is made of cemented carbide.

8. The silicon lump crushing tool set forth in claim 1, wherein the guide tube, the hammer head and the guide member are covered with a synthetic resin sheet excluding the area of the guide through-hole formed in the front face of the guide member.
